(19) United States
(12) Patent Application Publication
(10) Pub. No.: US 2025/0070171 A1
(43) Pub. Date: Feb. 27, 2025

(54) ANODE MATERIAL

(71) Applicant: TALGA TECHNOLOGIES LIMITED, Cambridgeshire (GB)

(72) Inventors: Claudio CAPIGLIA, Osaka (JP); Fengming LIU, Reading, Berkshire (GB); Sai SHIVAREDDY, Cambridge, Cambridgeshire (GB)

(21) Appl. No.: 18/721,746

(22) PCT Filed: Dec. 20, 2022
(86) PCT No.: PCT/IB2022/062514

§ 371 Date: Jun. 19, 2024

(30) Foreign Application Priority Data
Dec. 20, 2021 (AU) 2021904147

(51) Int. Cl. H01M 4/587; C01B 32/21; H01M 4/36

(52) U.S. Cl. CPC H01M 4/587; C01B 32/21; H01M 4/366; C01P 2002/72; C01P 2004/32; C01P 2004/61; C01P 2006/10; C01P 2006/11; C01P 2006/12; C01P 2006/40

(57) ABSTRACT

An anode material comprising graphite particles of predominantly two distinct sizes. Also described are a method for producing an anode material comprising graphite particles of predominantly two distinct sizes and a battery comprising an anode material as described.

### FIELD OF THE INVENTION

The present invention relates to an anode material. More particularly, the present invention further relates to an anode material comprising graphite particles of predominantly two distinct sizes.

The present invention still further relates to a method for producing an anode comprising an anode material in accordance with the present invention.

### BACKGROUND ART

It is presently known that the mixing of natural with synthetic graphite products in the preparation of anode materials provides a cost benefit. However, it is also known that such mixed anode materials provide a relative loss of performance compared to anode materials prepared from natural graphite products alone. Such natural graphite products provide a typical particle sizing of about 10 μm. Specifically, the cycle and capacity performance metrics are typically diminished in mixed anode materials of the prior art.

The anode material and method of the present invention have as one object thereof to overcome substantially one or more of the above-mentioned problems associated with the prior art, or to at least provide a useful alternative thereto.

The preceding discussion of the background art is intended to facilitate an understanding of the present invention only. This discussion is not an acknowledgement or admission that any of the material referred to is or was part of the common general knowledge as at the priority date of the application.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the word “graphite” or related terms such as “graphite particle(s)” will be understood to refer to natural graphite.

Throughout the specification and claims, unless the context requires otherwise, D₅₀ is to be understood to refer to the median value of the particle size distribution. Put another way, it is the value of the particle diameter at 50% in a cumulative distribution. For example, if the D₅₀ of a sample is a value X, 50% of the particles in that sample are smaller than the value X, and 50% of the particles in that sample are larger than the value X. Similarly, it is to be understood that reference to D₅₀, unless the context requires otherwise, may include reference to volume, mass and number D₅₀.

It is to be understood that the ranges provided herein include the stated range and any value or sub-range within the stated range. For example, a range from about 1 micrometer (μm) to about 2 μm, or about 1 μm to 2 μm, should be interpreted to include not only the explicitly recited limits of from between from about 1 μm to about 2 μm, but also to include individual values, such as about 1.2 μm, about 1.5 μm, about 1.8 μm, etc., and sub-ranges, such as from about 1.1 μm to about 1.9 μm, from about 1.25 μm to about 1.75 μm, etc. Furthermore, when “about” and/or “substantially” are/is utilised to describe a value, they are meant to encompass minor variations (up to +/−10%) from the stated value.

### DISCLOSURE OF THE INVENTION

In accordance with the present invention there is provided an anode material comprising graphite particles of predominantly two distinct sizes.

Preferably, the two distinct sizes of the graphite particles have a D₅₀ of:
(i) ≤about 5 μm; and
(ii) ≥about 10 μm.

In one preferred form of the present invention the two distinct sizes have a D₅₀ of about:
(i) 5 μm; and
(ii) 20 μm.

Preferably, the ratio of smaller particles to larger particles is between about 10:90 to 50:50.

In a preferred form, the ratio of smaller particles to larger particles is about 30:70.

In one form, the larger graphite particles may be provided in the form of a synthetic graphite material. In another form, the larger graphite particles may be provided in the form of a natural graphitic material.

Still preferably, the smaller graphite particles are provided in the form of a natural graphite material.

In one preferred form of the present invention the smaller graphite particles are provided in the form of secondary graphite particles that preferably approximate an oblate spheroid.

Preferably, the secondary graphite particles comprise an aggregate of ground primary graphite particles providing the approximate oblate spheroid form.

The secondary graphite particles preferably have a D₅₀ of less than:
(i) about 5 μm; or
(ii) about 2 μm.

The ground primary graphite particles are preferably spheronised and coated with a carbon-based material, being one or more of pitch, polyethylene oxide and polyvinyl oxide, then pyrolysed at a temperature between 880° C. to 1100° C. for a time in the range of 12 to 40 hours. The amount of carbon-based material in the secondary graphite particles is preferably in the range of 2 to 10 wt % relative to graphite.

The ground primary graphite particles preferably have a D₅₀ of:
(i) less than about 15 microns;
(ii) less than about 10 microns; or
(iii) in the range of about 0.5 to 6 microns.

Preferably, the ground primary graphite particles have a surface area of:
(i) about 2 to 60 m²/g;
(ii) 7 to 9 m²/g; or
(iii) 7 m²/g.

Preferably, the ground primary graphite particles have XRD characteristics of one or more of a d002 of >3.35 Å, an Lc of >1000 Å and an La of >1000 Å. In a preferred form, the ground primary graphite particles have XRD characteristics of each of a d002 of >3.35 Å, an Lc of >1000 Å and an La of >1000 Å, and a purity of >99.9%.

In accordance with the present invention there is further provided a method for producing an anode material comprising graphite particles of predominantly two distinct sizes as described hereinabove.

In accordance with the present invention there is still further provided a method for the production of a battery comprising an anode material produced in accordance with the method described hereinabove.

### BRIEF DESCRIPTION OF THE DRAWINGS

The present invention will now be described, by way of example only, with reference to one embodiment thereof and the accompanying drawings, in which: —

FIG. 1 is a diagrammatic representation of the preparation of an electrode using a graphite material comprised of graphite particles having predominantly two distinct sizes in accordance with the present invention;

FIG. 2 is a further diagrammatic representation of the preparation of an electrode using a graphite material comprised of graphite particles having predominantly two distinct sizes in accordance with the present invention, in which there is provided additional detail regarding process steps and electrode composition;

FIG. 3 is a representation of a method by which the electrical conductivity testing employed in the examples of the description of the present invention was undertaken;

FIG. 4 is a graphical representation of the first cycle efficiency of a half cell utilising the anode composition of the present invention;

FIG. 5 is a diagrammatic representation of a cross section through a single layer laminate cell utilised in charge/discharge testing of the anode material of the present invention;

FIG. 6 is a diagrammatic representation of the test conditions to which the single layer laminate cell of FIG. 5 was exposed;

FIG. 7 is a graphical representation of the charge/discharge characteristics in the 1st cycle in accordance with the test conditions of FIG. 6;

FIG. 8 is a graphical representation of the charge/discharge characteristics in the 3^{rd} cycle in accordance with the test conditions of FIG. 6;

FIG. 9 is a graphical representation of the comparative discharge rate characteristics of the anode material of the present invention;

FIG. 10 is a graphical representation of the discharge capacity change of the anode material of the present invention shown with reference to cycle performance (capacity);

FIG. 11 is a graphical representation of the discharge capacity change of the anode material of the present invention shown with reference to cycle performance (capacity retention);

FIG. 12 is a graphical representation of a comparison of the cycle characteristics of the Applicant's Talnode C (GKT-1) graphite material, the anode material of the present invention (referenced again as GTK1/ZH-16HY=30/70) and the ZH-16HY synthetic graphite product (capacity retention, 50° C. cycle); and

FIG. 13 is a graphical representation of a comparison of the cycle characteristics of the Applicant's Talnode C (GKT-1) graphite material, the anode material of the present invention (referenced again as GTK1/ZH-16HY=30/70) and the ZH-16HY synthetic graphite product (capacity retention, 50° C. cycle, enlarged view).

### BEST MODE(S) FOR CARRYING OUT THE INVENTION

The present invention provides an anode material comprising graphite particles of predominantly two distinct sizes.

The two distinct sizes of the graphite particles have a D₅₀ of:
(i) ≤about 5 μm; and
(ii) ≥about 10 μm.

For example, the two distinct sizes have a D₅₀ of about:
(i) 5 μm; and
(ii) 20 μm.

The ratio of smaller particles to larger particles is between about 10:90 to 50:50. In a preferred form, the ratio of smaller particles to larger particles is about 30:70.

The larger graphite particles may be provided in the form of either a synthetic graphite material or a natural graphitic material. The smaller graphite particles are provided in the form of a natural graphite material.

In one preferred form of the present invention the smaller graphite particles are provided in the form of secondary graphite particles that preferably approximate an oblate spheroid. The Applicant has previously described these secondary graphite particles in International Patent Application PCT/IB2020/058910 (WO2021/059171) and the entire content thereof is incorporated herein by reference. These secondary graphite particles are referred to by the Applicant as Talnode C™ or Talnode-C™.

The secondary graphite particles comprise an aggregate of ground primary graphite particles. The ground primary graphite particles are preferably spheronised and coated with a carbon-based material, being one or more of pitch, polyethylene oxide and polyvinyl oxide, then pyrolysed at a temperature between 880° C. to 1100° C. for a time in the range of 12 to 40 hours. The amount of carbon-based material in the secondary graphite particles is preferably in the range of 2 to 10 wt % relative to graphite.

The ground primary graphite particles may have a D₅₀ of:
(i) less than about 15 microns;
(ii) less than about 10 microns; or
(iii) in the range of about 4 to 6 microns.

The ground primary graphite particles have a surface area of about 2 to 9 m²/g, for example 7 to 9 m²/g or 7 m²/g. Further, the ground primary graphite particles have XRD characteristics of one or more of a d002 of >3.35 Å, an Lc of >1000 Å and an La of >1000 Å. In a preferred form, the ground primary graphite particles have XRD characteristics of each of a d002 of >3.35 Å, an Lc of >1000 Å and an La of >1000 Å, and a purity of >99.9%.

The Applicant further envisages that the small graphite particles may be provided in the form of the ground primary graphite particle described herein or in the form of the silicon and graphite containing composite material described in the Applicant's International Patent Application PCT/IB2020/056050 (WO2020/261194), the entire content of which is hereby incorporated by reference.

The present invention further provides a method for producing an anode material comprising graphite particles of predominantly two distinct sizes as described hereinabove and described hereinafter.

The present invention still further provides a method for the production of a battery comprising an anode material prepared in accordance with the method described hereinabove and described hereinafter.

Table 1 below provides an example of an appropriate ground primary graphite particle for use in/as used in the method of the present invention, whilst Table 2 provides the elemental analysis thereof.

TABLE 1

| Property | Value | | Method |
|---|---|---|---|
| Carbon Content | >99.9% | | LECO (C %, S %). Loss of |
| | | | Ignition (LOI) |
| Surface Area | 2-9 | m²/g | Bernauer-Emmett-Teller (BET) |
| Particle size | 3-15 | μm | Particle size analyzer |
| D₁₀ | 1~3 | μm | |
| D₅₀ | 4~6 | μm | |
| D₉₀ | 7-10 | μm | |
| Bulk Density | 0.2-1 | g/cc | Bulk density apparatus |
| d1002 | >3.35 | Å | XRD |
| Lc | >1000 | Å | |
| La | >1000 | Å | |

TABLE 2

| C | Al | Ca | Cu | Fe | K | Mg | Mn | Si | S | ELEMENTS |
|---|---|---|---|---|---|---|---|---|---|---|
| >99.9% | 3.3 | 7.4 | 7.3 | 26.7 | 5.7 | 2.9 | 0.2 | <0.1 | 37 | ppm |

The process of the present invention may be better understood with reference to the following non-limiting example.

### Example

### Electrode Preparation

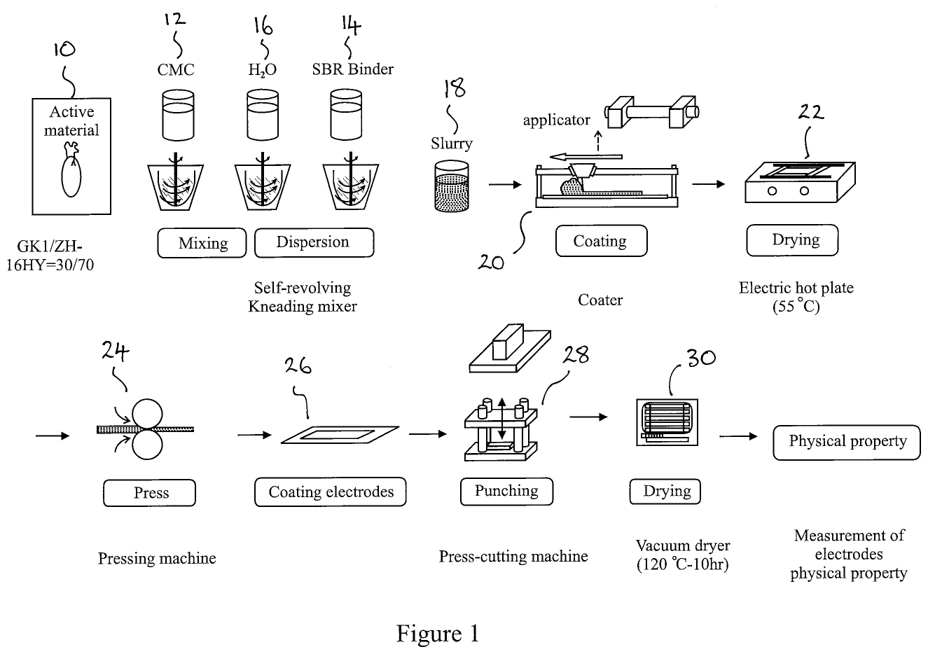

The procedure employed for the preparation of an anode, incorporating an anode material 10 in accordance with the present invention, is shown in FIG. 1, wherein a CMC (carboxymethyl cellulose) aqueous solution 12 (BSH-12/1% aqueous solution) was used as a thickener. SBR or styrene butadiene rubber (TRD2001™) was used as a binder 14. Distilled water 16 was used as a solvent. After preparation of the slurry 18, coating was performed with an applicator 20. Drying 22 was performed at 55° C. after slurry coating. Thereafter, pressing 24, coating of electrodes 26, punching 28 and finally a curing treatment 30 by vacuum drying 120° C.-10 hr was performed.

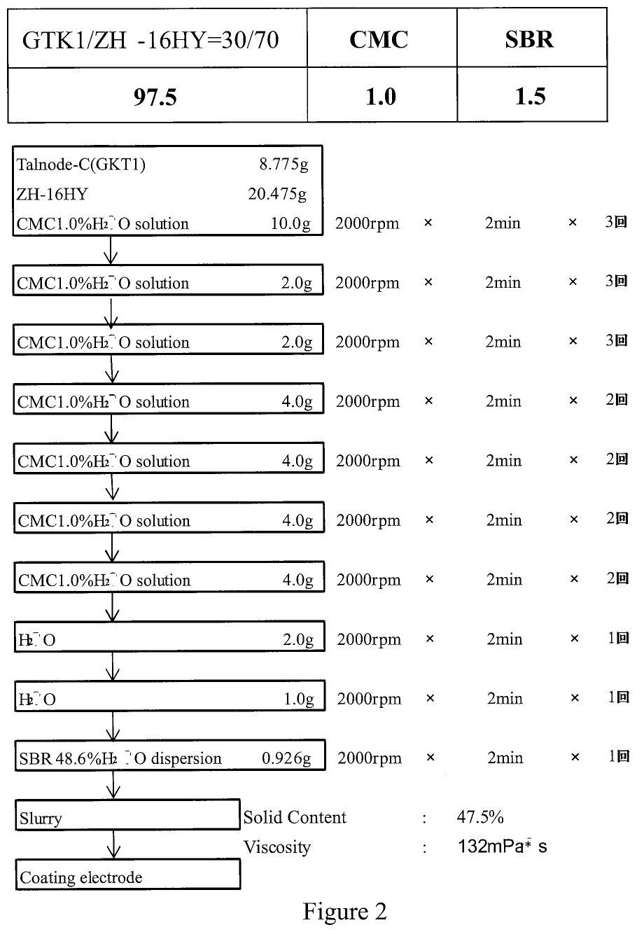

The anode material of the present invention employed, as is evidenced by FIGS. 1 and 2, is a combination of the Applicant's Talnode C product, designated variously as GKT-1 or GKT1, and Long Time Technology Co., Ltd's ZH-16HY synthetic graphite product. The characteristics of the ZH-16HY synthetic graphite product are set out in Table 3 below.

TABLE 3

| Item | | Unit | Specification | Method |
|---|---|---|---|---|
| Particle | D₁₀ | μm | 6-9 | GB/T 24533-2009 App. A |
| Size | D₅₀ | | 13-17 | (0.2 ml 10% NP-40 |
| | D₉₀ | | ≤35 | solution was used |
| | | | | to improve dispersion |
| | | | | of graphite in water). |

| | | | |
|---|---|---|---|
| Tap density | g/cm³ | ≥1.00 | GB/T 24533-2009 App. M |
| Specific surface | m²/g | ≤2.0 | GB/T 24533-2009 App. D |
| area | | | |
| Moisture content | % | ≤0.10 | GB/T 3521-2008 |
| Ash content | % | ≤0.05 | GB/T 3521-2008 |
| Fixed carbon | % | ≥99.95 | GB/T 3521-2008 |
| content | | | |
| True density | g/cm³ | ≥2.20 | GB/T 24533-2009 App. E |
| Charge/ | C | 10 C/50 C | |
| Discharge Rate | | | |
| (Suggestion) | | | |
| 1^{st} Discharge cap | mAh/g | ≥350 | Half cell test (CR2032) |
| 1^{st} Coulombic eff. | % | ≥92 | In the range of 0.001-2 |
| | | | V at 0.1 C |

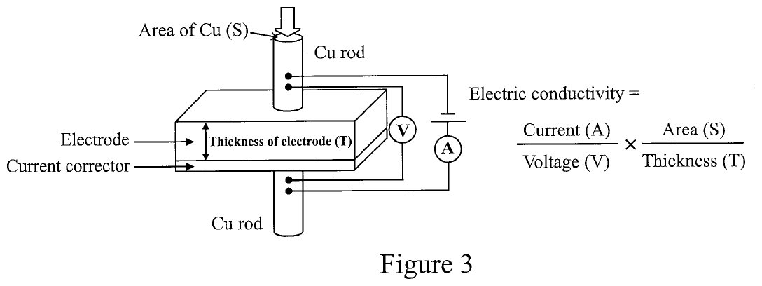

The electrode was prepared by using a CMC aqueous solution (BSH-12/1% aqueous solution), SBR (TRD2001™) binder. The slurry preparation procedure, the slurry solid content, and the viscosity of the prepared electrode are shown in FIG. 2. The slurry preparation utilises a kneading mixer. As a result of preparing the slurry in this manner, no aggregates could be identified. That is, the slurry was of a generally smooth consistency. The composition and testing results for the electrode are summarised and set out in Table 4 below. Electrical conductivity testing being conducted in accordance with the arrangement shown in FIG. 3.

### Strength Test

The minimum strength of the electrode was checked as to whether the electrode can be used in electrochemical testing.

### Winding Test

The electrode was evaluated by winding it to the stainless steel rods of 4 mm in diameter. If cracking and peel-off occurred on the electrode, the strength of the electrode was judged to be insufficient. In such a case, the compounding ratio of the electrode would need to be re-evaluated.

### Impregnation Test by Acetone

The electrode was evaluated by impregnation to acetone (lower viscosity and more rapid permeability in electrolyte solutions) and checked whether peel-off from the current collector foil had occurred. If there was no peel-off nor any other problem evident from the acetone impregnation test, the strength of the electrode is considered to be sufficient. Note, peel-off and other problems in the reliability testing cannot be checked.

### Powder Fall Test

The surface of the electrode was rubbed with a paper waste to check for the presence of powder.

TABLE 4

| Active Material | GTK1/ZH-16HY = 30/70 | |
|---|---|---|
| Compounding ratio | 97.5 wt % | |
| Binder | CMC | |
| | 1.0 wt % | |
| | SBR | |
| | 1.5 wt % | |
| Current Collector | Cu foil (10 μm) | |
| Coating weight | 10.8 | mg/cm² |
| Thickness | 75 | μm |
| Density | 1.44 | g/cm³ |
| Electrical conductivity | 3.2 × 10⁻¹ | S/cm |

| | |
|---|---|
| Strength test | Winding (4 mm^{ϕ}): 0 |
| | Powder falling: 0 |
| | Impregnation (Acetone): 0 |

### Composition and Electrode Property

The prepared electrodes were adjusted to have the loading of 10.8 m/cm² and a density of 1.44 g/cm³. There is no problem in terms of strength, and the conductivity is almost the same level as other samples. GTK1/ZH-16HY=30/70 shows some spring back effect during electrode preparation. Comparative details of properties of electrodes prepared either in accordance with the present invention (first column) or from a graphite material of a single size distribution (second column) are shown in Table 5 below.

TABLE 5

| Active material | | | | |
|---|---|---|---|---|
| compounding | GTK1/ZH-16HY = 30/70 | | Talnode-C(GTK1) | |
| ratio | 97.5 wt % | | 97.5 wt % | |
| Binder | CMC | | CMC | |
| | 1.0 wt % | | 1.0 wt % | |
| | SBR | | SBR | |
| | 1.5 wt % | | 1.5 wt % | |
| Current | Cu foil (10 μm) | | Cu foil (10 μm) | |
| Collector | | | | |
| Coating weight | 10.8 | mg/cm² | 10.8 | mg/cm² |
| Thickness | 75 | μm | 71 | μm |
| Density | 1.44 | g/cm³ | 1.52 | g/cm³ |
| Electrical | 3.2 × 10⁻¹ | S/cm | 2.4 × 10⁻¹ | S/cm |

| | | |
|---|---|---|
| conductivity | | |
| Strength test | Winding (4 mm^{ϕ}): 0 | Winding (4 mm^{ϕ}): 0 |
| | Powder fall test: 0 | Powder fall test: 0 |
| | Impregnation (Acetone): 0 | Impregnation (Acetone): 0 |

The piece of sample electrode (size: 50 mm×20 mm, 10 cm²) was dried for 10 hr at 120° C. The electrode density was calculated after measuring the thickness and the weight without blank value of current collecting foils.

### Half Cell Configuration and Charge/Discharge Test Conditions

Half cell configuration is as shown in Table 6 below, and the half cell for evaluation is a three-pole type cell using Li metal as a counter electrode and a reference electrode. The evaluation electrode was punched a size of 17 mm Φ and then vacuum dried at 120° C.×10 h, cell preparation was performed in a dry box with a dew point of −80° C. or less. Moreover, the half cell characteristic was measured on the charging/discharging conditions, again as shown in Table 6 below.

TABLE 6

| | | |
|---|---|---|
| Configurations | Working electrode | Evaluation samples |
| | Counter electrode | Li metal |
| | Reference electrode | Li metal |
| | Separator | PE microporous film, |
| | | Glass fiber fabric |
| | Electrolyte | 1M-LiPF₆/3EC7MEC |
| Charge/Discharge | Charge condition | 0.2 C, 10 mV-CCCV |
| Test Condition | | (0.05 C cut) |
| | Discharge condition | 0.2 C, 2.5 V-CC |
| | Cycle amount | 10 cycle |
| | Temperature | 25° C. |

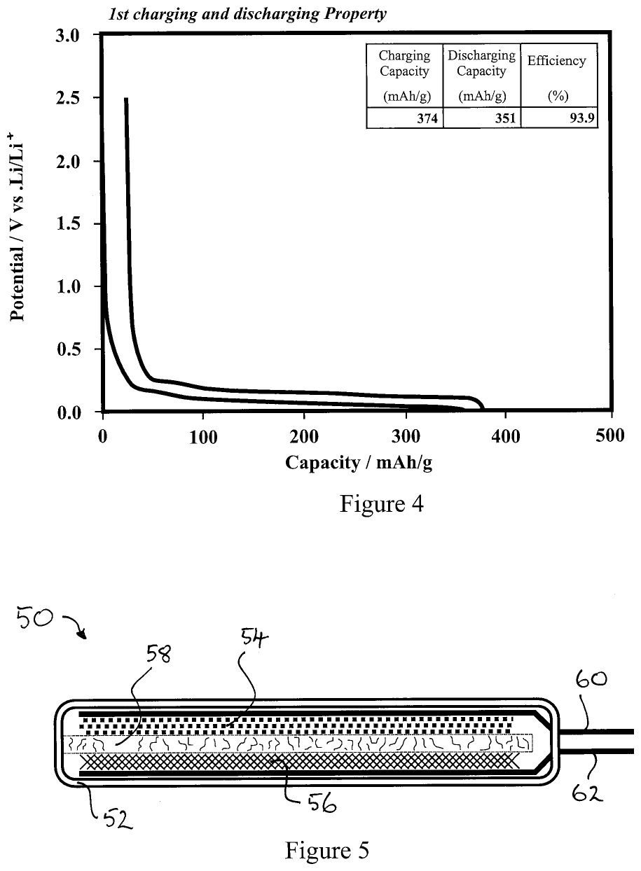

The first cycle efficiency for GTK1/ZH-16HY is shown in FIG. 4.

### Configuration of Single Layer Laminate Cell

A single layer laminate cell was punched out with positive electrode (30 mm×50 mm) and negative electrode (32 mm×52 mm). The dried positive electrode (170° C.×10 h drying), and negative electrode (120° C.×10 h drying) are opposed through a separator (70° C.×10 h drying), and inserted into the Al laminate outer package. An electrolyte was then poured into the cell, followed by vacuum impregnation. Finally, the cell was sealed in a vacuum. The cell configuration is shown in FIG. 5 and Table 7 below shows the details of the cell composition.

FIG. 5 shows a full cell 50 incorporating the anode material and anode in accordance with the present invention. The full cell 50 comprises an aluminium laminate film or outer package 52, a negative electrode or anode 54 in accordance with the present invention, a positive electrode or cathode 56, and a separator 58, each arranged in substantially known manner. The anode 54 further comprises a copper current collector 60 and the cathode 56 further comprises an aluminium current collector 62.

### Charge/Discharge Test Condition

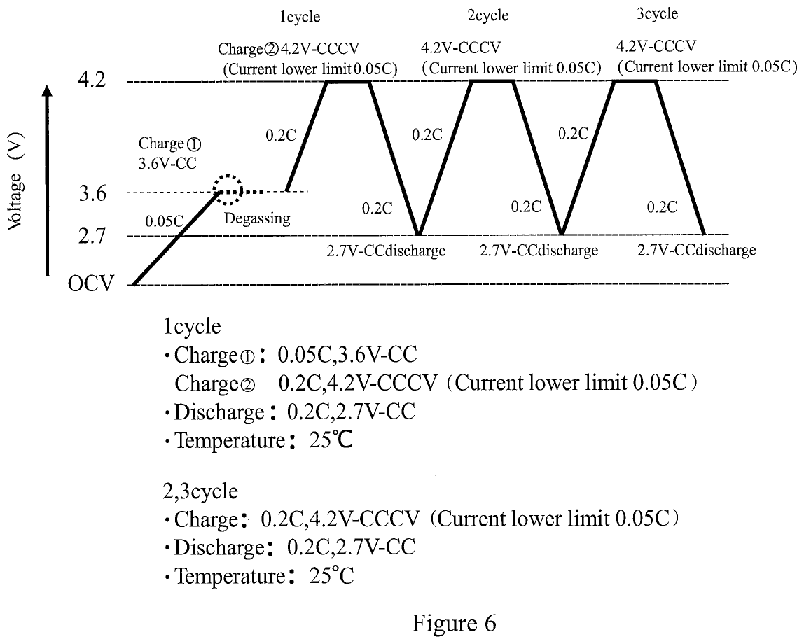

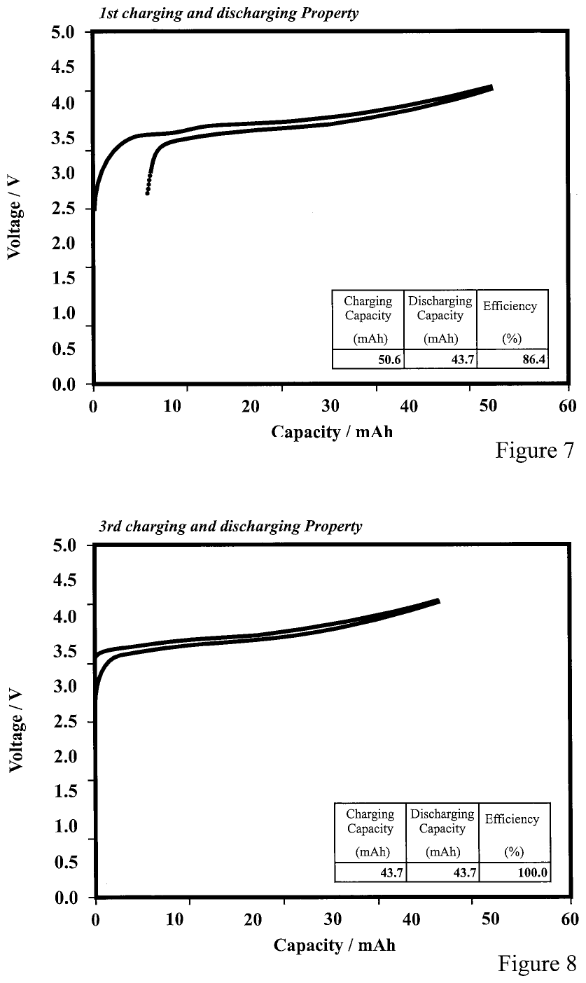

After preparation of the cell, the evaluation cell was subjected to charge/discharge tests of 3 cycles in a voltage range of 4.2V-2.7V at 25° C. Detailed test conditions are shown in FIG. 6, and the charge/discharge characteristics in the 1st and 3^{rd} cycles are shown in FIGS. 7 and 8, respectively. Table 7 below provides a summary of the charge/discharge results.

TABLE 7

| | | GTK1/ZH- | Talnode-C | T-13 | |
|---|---|---|---|---|---|
| | | 16HY = 30/70 | (GTK1) | (coating/round) | Talnode-C |
| 1cy | Charging Capacity (mAh) | 50.6 | 51.8 | 52.8 | 52.9 |
| | Discharging Capacity (mAh) | 43.7 | 44.3 | 43.8 | 44.1 |
| | Efficiency(%) | 86.4 | 85.6 | 83.1 | 83.4 |
| 3cy | Charging Capacity (mAh) | 43.7 | 44.4 | 43.6 | 43.8 |
| | Discharging Capacity (mAh) | 43.7 | 44.1 | 43.2 | 43.3 |
| | Efficiency(%) | 100.0 | 99.4 | 99.1 | 99.0 |

### Current Rest Method (CRM) Resistance Schematic and Condition

In battery/capacitor evaluation, the input/output characteristics, which greatly affect the resistance characteristics, are important. The input/output characteristics are directly related to the internal resistance of the device, and the DC internal resistance evaluation was conducted using “Current-Rest-Method” (C.R.M.) proposed by Dr. S. Yata as an input/output evaluation method (S. Yata, Practical evaluation technology on lithium ion batteries and capacitors (No. 1357), Technical Information Institute Co., Ltd. (2006); and S. Yata, The sequel to practical evaluation technology on lithium ion batteries and capacitors (No. 1516) Technical Information Institute Co., Ltd. (2009)).

In this method, it is possible to evaluate the resistance corresponding to the input/output of about up to 60 seconds, however, it is necessary to pay attention to the consideration when there are effects of relaxation (diffusion) due to at least concentration polarization, heterogeneous reaction, and resistance heating effect during charge/discharge (low temperature).

### Charge/Discharge Condition in C.R.M. Resistance Measurement:

Charge process; Repeat “charge 12 min-rest 1 min” pattern up to upper limit of 4.2V, Current 0.5 C, Rest width ΔSOC10% equivalent.

Discharge process; Repeat “discharge 12 min-rest 1 min” pattern up to lower limit of 2.7V, Current 0.5 C, Rest width ΔSOC10% equivalent.

Measurement temperature; 25° C., 0° C. (only discharge process)

### Analysis of C.R.M. Resistance:

C.R.M. resistance; Resistance calculated from voltage change from 0 sec to 60 sec. Measure time-rate resistance up to 60 seconds for each SOC.

Ohmic component; Resistance calculated from voltage change from 0 sec to 1 sec. (1 second rate resistance).

Relaxation component; Resistance calculated from voltage change from 1 sec to 60 sec. Equilibrium/relaxation resistance from 1 sec to 60 sec.

A summary of the CRM resistance and A.C. Resistance is provided in Table 8 below:

TABLE 8

| | | | GTK1/ZH- | Talnode- |
|---|---|---|---|---|
| | | | 16HY = 30/70 | C(GTK1) |
| CRM resistance | C.R.M | | 1.65 | 1.39 |
| | residence(Ω) | | | |
| | Ohmic | | 0.88 | 0.72 |
| | compound(Ω) | | | |
| | Relaxation | | 0.77 | 0.67 |
| | compound(Ω) | | | |
| A.C. Resistance | 50 | kHz(Ω) | 0.26 | 0.25 |
| (25° C.) | 20 | kHz(Ω) | 0.27 | 0.27 |
| | 10 | kHz(Ω) | 0.29 | 0.27 |
| | 1 | kHz(Ω) | 0.40 | 0.34 |
| | 100 | Hz(Ω) | 0.60 | 0.50 |
| | 10 | Hz(Ω) | 0.79 | 0.64 |
| | 1 | Hz(Ω) | 0.83 | 0.69 |
| | 0.1 | Hz(Ω) | 0.88 | 0.74 |

| | | | |
|---|---|---|---|
| Bulk Resistance(Ω) | (Ω) | 0.27 | 0.27 |
| Arc termination | (Ω) | 0.83 | 0.69 |
| resistance(Ω) | | | |
| Reaction | (Ω) | 0.56 | 0.42 |
| resistance(Ω) | | | |

### Discharge Rate Characteristics

The measurement conditions of discharge rate characteristics were:
Charge: 0.2 C, 4.2V-CCCV (Current lower limit 0.05 C)
Discharge: 0.5 C, 1.0 C, 2.0 C, 2.7V-CC (After discharging at each current, remaining discharge was performed at 0.2 C)
Temperature: 25° C.

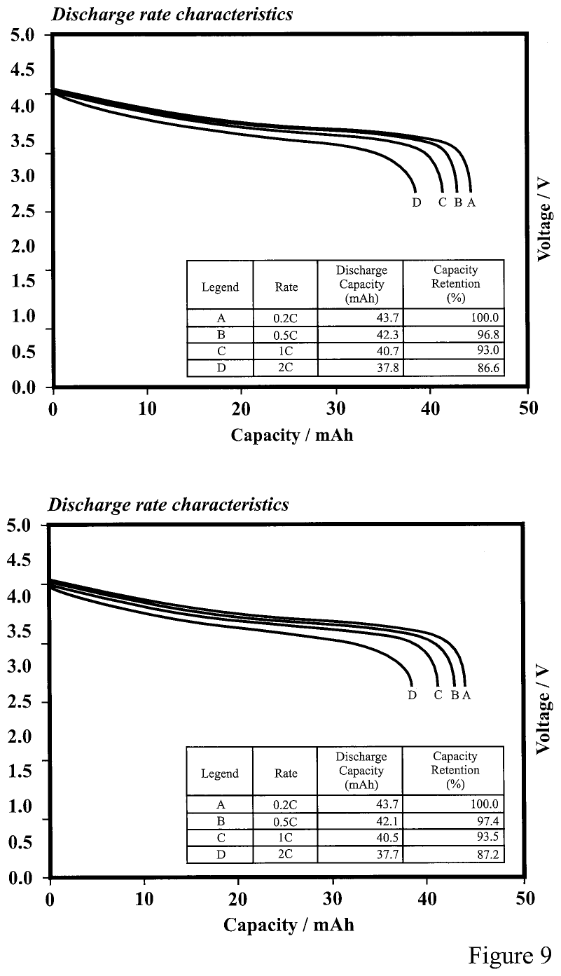

In the case of the GTK1/ZH-16HY electrode the maintenance rate of the 2 C rate is 86.6%, which is slightly lower than that of Talnode-C (GTK1) but relatively maintained. There is no significant reduction due to the mixing or ‘bi-modal’ distribution. The comparative discharge rate characteristics are shown in FIG. 9 and Table 9 below:

TABLE 9

| | | GTK1/ZH-16HY = 30/70 | | Talnode-C(GTK1) | |
|---|---|---|---|---|---|
| Discharge | | Capacity | Capacity | Capacity | Capacity |
| rate | | [mAh] | retention[%] | [mAh] | retention[%] |
| 0.2 | C | 43.7 | 100.0 | 44.0 | 100.0 |
| 0.5 | C | 42.3 | 96.8 | 42.8 | 97.3 |
| 1 | C | 40.7 | 93.0 | 41.5 | 94.2 |
| 2 | C | 37.8 | 86.6 | 38.6 | 87.7 |

### Measurement of Storage Characteristics

Storage characteristics of the anode material of the present invention were investigated under the following conditions:

60° C. storage test conditions
Test condition: 60° C.
Storage cell status: SOC100%
Storage period: 30 days
Regularly measure the voltage (25° C.)

After storage: checking OCV, remaining capacity, recovery capacity, AC resistance, gas volume measurement (volumetric measurement before the test and at each test period, measuring the amount of gas generated).

After storage, 25° C. for characterization.

25° C. Test conditions
Charge: 0.2 C, 4.2V-CCCV (Current lower limit 0.05 C)
Discharge: 0.2 C, 2.7V-CC
Temperature: 25° C.

A summary of the storage characteristics are provided in Table 10 below.

TABLE 10

| | | | GTK1/ZH- | Talnode-C |
|---|---|---|---|---|
| | | | 16HY = 30/70 | (GTK1) |
| OCV | Before(V) | | 4.18 | 4.19 |
| | After(V) | | 4.08 | 4.02 |
| | [symbol] V(V) | | 0.10 | 0.17 |
| After 30 days of | Remaining | | 35.5 | 28.7 |
| 60° C. storage | capacity (mAh) | | | |
| remaining | Recovery charge | | 38.4 | 33.3 |
| capacity, | capacity (mAh) | | | |
| recovery | Recovery | | 38.7 | 33.5 |
| capacity | discharge capacity | | | |
| | (mAh) | | | |
| | Efficiency(%) | | 100.8 | 100.8 |
| | Remaining capacity | | 80.8 | 65.7 |
| | retention(%)※ | | | |
| | Recovery capacity | | 88.2 | 76.8 |
| | retention(%)※ | | | |
| After 30 days of | 50 | kHzΩ | 0.49 | 0.54 |
| 60° storage | 20 | kHzΩ | 0.55 | 0.59 |
| A.C. Resistance | 10 | kHzΩ | 0.58 | 0.62 |
| (25° C.) | 1 | kHzΩ | 0.71 | 0.74 |
| | 100 | HzΩ | 0.9 | 0.89 |
| | 10 | HzΩ | 1.13 | 1.12 |
| | 1 | HzΩ | 1.28 | 1.41 |
| | 0.1 | HzΩ | 1.33 | 1.48 |

| | | | |
|---|---|---|---|
| Bulk Resistance | Ω | 0.47 | 0.47 |
| Arc termination | Ω | 1.29 | 1.44 |
| resistance | | | |
| Reaction | Ω | 0.83 | 0.97 |
| resistance | | | |
| Gas volume | (cc) | 0.01 | 0.10 |

※capacity retention: initial 3^{rd} cycle discharge capacity reference.

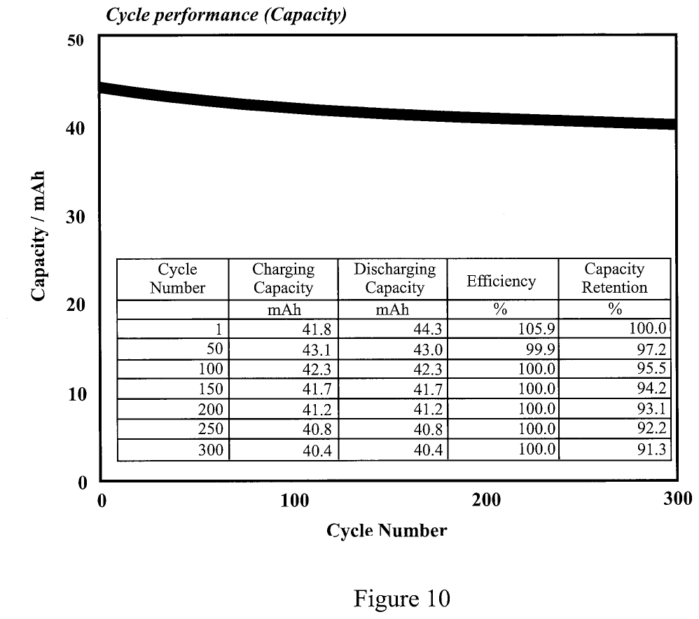

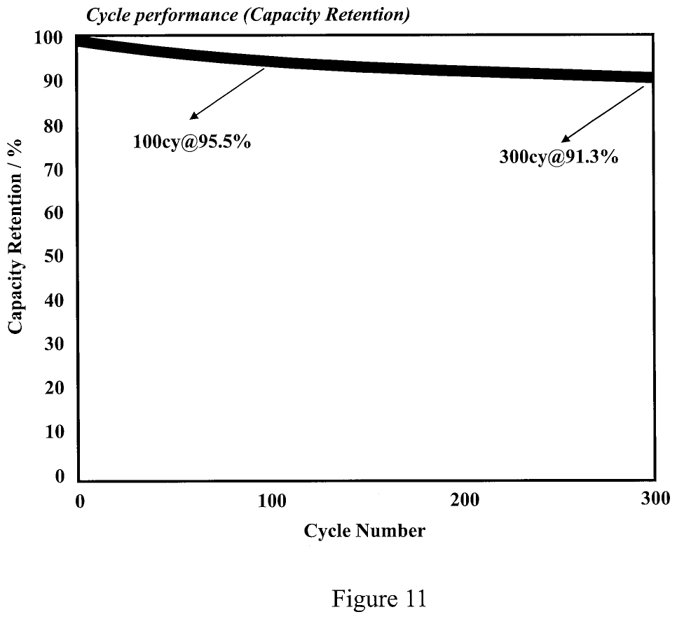

The discharge capacity change of the anode material Talnode C (GTK1) is shown with reference to FIGS. 10 and 11, in which cycle performance (capacity) and cycle performance (capacity retention) are shown, respectively.

The capacity retention for 100 cycles is 91.8%, as seen in FIG. 11, which is understood by the Applicant to be an objectively high result. In addition, when testing was continued to 300 cy capacity retention was 85%, which is understood to be an excellent characteristic.

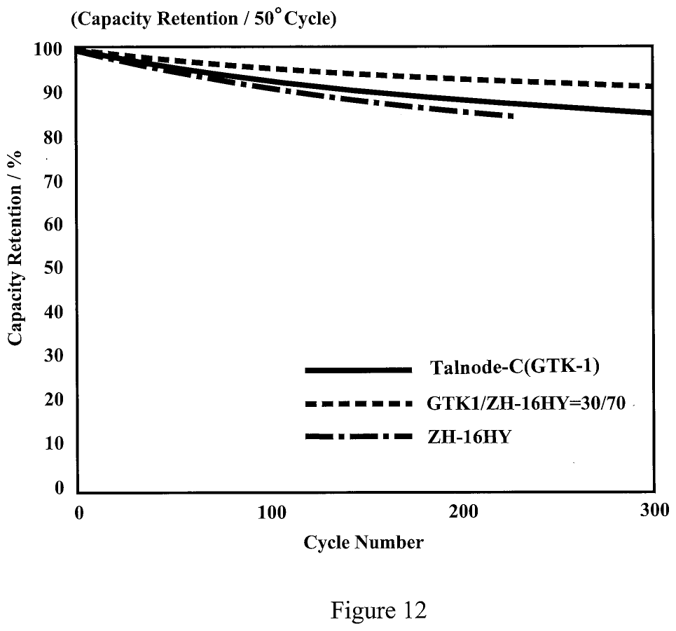

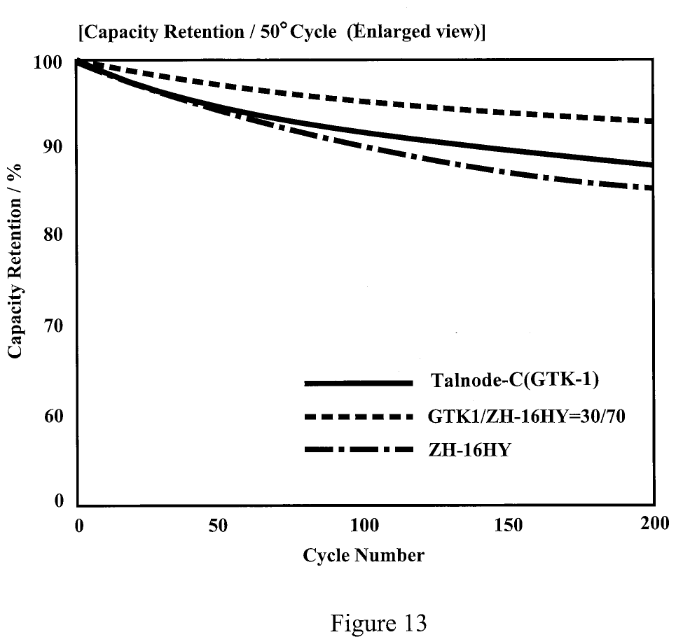

A comparison of the cycle characteristics of the Applicant's Talnode C (GTK-1) graphite material, the anode material of the present invention (referenced again as GTK1/ZH-16HY=30/70) and the ZH-16HY synthetic graphite product is shown in FIG. 12 (capacity retention, 50° C. cycle) and FIG. 13 (capacity retention, 50° C. cycle, enlarged view).

The cycle characteristics of ZH-16HY alone show a maintenance rate of 86% at 200 cycles, which is slightly inferior to that of Talnode C (CGK-1). The results for GTK1/ZH-16HY=30/70, the anode material of the present invention, are demonstrably better than those of Talnode C (CGK-1) and ZH-16HY, and are considered excellent by the Applicant.

The Applicant has attributed the cause of the improvement to the bimodal particle distribution effect and it is further understood to potentially be due to the particle size balance and the relative binder ratio. The bimodal distribution optimises the electrode loading and the stress absorbed by the particles during calendaring, giving an improved and substantially homogeneous distribution of particles into the electrode. This in turn keeps the conduction path into the electrode while long cycling, hence the improvement in cycling performance.

A summary of durability (50° C. cycle, 60° C. storage) characteristics is provided in Table 11 below for comparison purposes. Included in the comparison is the Applicant's Talnode C (GTK-1) graphite material and the anode material of the present invention (referenced again as GTK1/ZH-16HY=30/70).

TABLE 11

| | | | | | | 50° C. cycle | | |
|---|---|---|---|---|---|---|---|---|
| | | | | | Initial | (@100 cy) | 60° C. storage (30 days) | |
| | Particle | | | | efficiency | Capacity | Remaining | Recovery |
| | distribution (μm) | | | SSA | (half-cell) | Retention | capacity | capacity |
| Sample name | D₁₀ | D₅₀ | D₉₀ | (m²/g) | (%) | (%) | (%) | (%) |
| Talnode-C(GTK-1) | 2.1 | 4.1 | 7.6 | 5.8 | 91.1 | 91.8 | 65.7 | 76.8 |
| GTK1/ZH-16HY = 30/70 | — | | | | — | 95.5 | 80.8 | 88.2 |
| Talnode-C(GKT-1) | 2.1 | 4.1 | 7.6 | 5.8 | 91.1 | 91.8 | 65.7 | 76.8 |
| GTK1/ZH-16HY = 30/70 | | | | | 93.9 | 95.5 | 80.8 | 88.2 |
| ZH-16HY | 8.4 | 15.9 | 32.1 | — | 93.1 | 90.8 | 87.6 | 93.8 |

As can be seen with reference to the above description, the anode composition of the present invention can achieve a loading of up to 1.7 gr/cm² and significantly improve cycle life relative to anode compositions of the prior art.

It is further readily apparent that the anode material of the present invention, being a combination of graphite particles of predominantly two distinct sizes, provides improved performance relative to anode materials comprised of only one or other of those two distinctly sized anode materials. The Applicant refers to this effect as a ‘bimodal effect’. This ‘bimodal effect’ can be assigned a numerical value based on the ratio of the larger particles to the smaller particles in the combination. For example, the product referenced throughout as GTK1/ZH-16HY=30/70 is composed of the GTK1 particles at a size of about 5 μm and the ZH-16HY particles at a size of about 20 μm, giving a ‘bimodal effect’ of 4.

Modifications and variations such as would be apparent to the skilled addressee are considered to fall within the scope of the present invention.

1. An anode material comprising graphite particles of predominantly two distinct sizes, wherein the smaller graphite particles are provided in the form of secondary graphite particles that approximate an oblate spheroid and the larger graphite particles are provided in the form of a synthetic graphite material or a natural graphitic material.

2. The anode material of claim 1, wherein the two distinct sizes of the graphite particles have a D₅₀ of:
(i) ≤about 5 μm; and
(ii) ≥about 10 μm.

3. The anode material of claim 1, wherein the two distinct sizes have a D₅₀ of about:
(i) 5 μm; and
(ii) 20 μm.

4. The anode material of claim 1,
wherein the ratio of smaller particles to larger particles is between about 10:90 to 50:50.

5. The anode material of claim 4, wherein the ratio of smaller particles to larger particles is about 30:70.

6. The anode material of claim 1, wherein the smaller graphite particles are provided in the form of a natural graphite material.

7. The anode material of claim 1, wherein the secondary graphite particles comprise an aggregate of ground primary graphite particles providing the approximate oblate spheroid form.

8. The anode material of claim 7, wherein the secondary graphite particles have a D₅₀ of less than:
(i) about 5 μm; or
(ii) about 2 μm.

9. The anode material of claim 7, wherein the ground primary graphite particles are spheronised and coated with a carbon-based material, being one or more of pitch, polyethylene oxide and polyvinyl oxide, then pyrolysed at a temperature between 880° C. to 1100° C. for a time in the range of 12 to 40 hours.

10. The anode material of claim 9, wherein the amount of carbon-based material in the secondary graphite particles is in the range of 2 to 10 wt % relative to graphite.

11. The anode material of claim 7, wherein the ground primary graphite particles have a D₅₀ of:
(i) less than about 15 microns;
(ii) less than about 10 microns; or
(iii) in the range of about 0.5 to 6 microns.

12. The anode material of claim 7, wherein the ground primary graphite particles have a surface area (BET) of:
(i) about 2 to 60 m²/g;
(ii) 7 to 9 m²/g; or
(iii) 7 m²/g.

13. The anode material of claim 7, wherein the ground primary graphite particles have XRD characteristics of:
(i) one or more of a d002 of >3.35 Å, an Lc of >1000 Å and an La of >1000 Å; or
(ii) each of a d002 of >3.35 Å, an Lc of >1000 Å and an La of >1000 Å, and a purity of >99.9%.

14. A method for producing an anode material comprising graphite particles of predominantly two distinct sizes as described in claim 1.

15. A method for the production of a battery comprising an anode material produced in accordance with the method of claim 14.
